(19) United States
(12) Patent Application Publication
(10) Pub. No.: US 2012/0301862 A1
(43) Pub. Date: Nov. 29, 2012

(54) METHOD FOR PROVIDING EDUCATION AND ENTERTAINMENT

(76) Inventor: DONALD SPECTOR, New York, NY (US)

(21) Appl. No.: 13/568,250

(22) Filed: Aug. 7, 2012

Related U.S. Application Data
(63) Continuation-in-part of application No. 12/316,504, filed on Dec. 12, 2008.
(60) Provisional application No. 61/013,310, filed on Dec. 13, 2007.

(51) Int. Cl. G09B 7/00

(52) U.S. Cl. 434/350

(57) ABSTRACT

A method for providing continuing education involves editing an entertainment program that contains relevant facts about a particular subject. The program is accessible over the internet to participants, who are quizzed periodically during the program based on the facts. The program continues when the correct answers are input. Once the program is completed, a completion certificate is sent to the participants.

### CROSS-REFERENCE TO RELATED APPLICATIONS

This application is a continuation-in-part of U.S. patent application Ser. No. 12/316,504, filed on Dec. 12, 2008, which claims priority under 35 U.S.C. 119(e) of U.S. Provisional Application Ser. No. 61/013,310, filed on Dec. 13, 2007.

### BACKGROUND OF THE INVENTION

1. Field of the Invention

This invention relates to a method for providing continuing education in combination with an entertainment program.

2. The Prior Art

Continuing Education (CE) is a requirement in many professions, and often mandated by state licensing boards. Many people for whom CE is mandated have difficulty fulfilling the requirements. The programs offered by local associations are often expensive, time consuming and uninteresting.

There have been efforts to combine mandatory CE with entertainment events, in the form of conferences that take place over the course of a week or weekend. While these conferences can be enjoyable, the cost and inconvenience of traveling makes this not a viable option for many.

### SUMMARY OF THE INVENTION

It is therefore an object of the invention to create a platform for providing education in combination with an existing entertainment program to fulfill accredited CE requirements while simultaneously entertaining the participants.

It is another object of the invention to provide the program as a broadcast over the internet to an individual's computer.

It is another object of the invention to provide an education and entertainment program that quizzes the watcher during the program and re-runs the program until the watcher answers the questions correctly.

This object is accomplished according to the invention by a method for providing education that involves taking an existing entertainment program and editing it so that it contains relevant facts about a particular subject. The program is accessible over the internet by a user who plays the program on their personal computer, tablet or smartphone.

During the program, the user is questioned as to various facts that have been conveyed during the program, and the user is prompted to enter answers into the computer. Upon the correct answers being entered, the program continues. If the incorrect answers are input, the program replays from a designated point in the program, so that the user is exposed to the facts again. The user is then quizzed and the program is replayed again until the correct answers are entered. This is continued at designated intervals until the program is completed.

Upon entering correct answers for the final questions, the user receives continuing education credits. Completion certificates can be awarded to all passing participants. Since the program itself contains all of the relevant information on the subject being tested, the participants obtain their education credits while being entertained at the same time.

The entertainment program can take any suitable form, for example an opera, a play, a ballet, a musical, a movie or a comedy program. Other types of entertainment programs could also be envisioned.

Supplemental materials could also be distributed to the participants, either before or after the entertainment program. These supplemental materials are electronic files containing the relevant subject matter on which the entertainment program is based. The supplemental materials could also include a written program, similar to a “Playbill” that includes interesting information about the entertainment aspects as well.

The program can provide education in any field. Some examples are the fields of nursing, law, medicine or education. Even technical fields such as computer programming or plumbing could be used. The invention could be used for fulfilling mandatory continuing education requirements within one's profession, or could also be used as part of a degree-granting program of an educational institution.

The participants can pay for the program by sending the credit card information to the server, which can process the payment via usual credit card processing software.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

FIG. 1 is a block diagram of the components used in the method according to the invention; and

FIG. 2 is a flow diagram of one embodiment of the method according to the invention.

### DETAILED DESCRIPTION OF THE PREFERRED EMBODIMENT

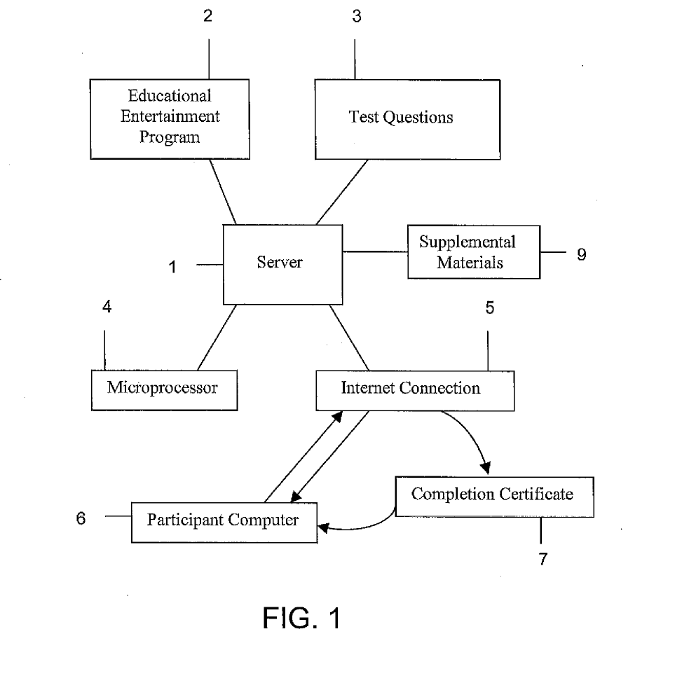

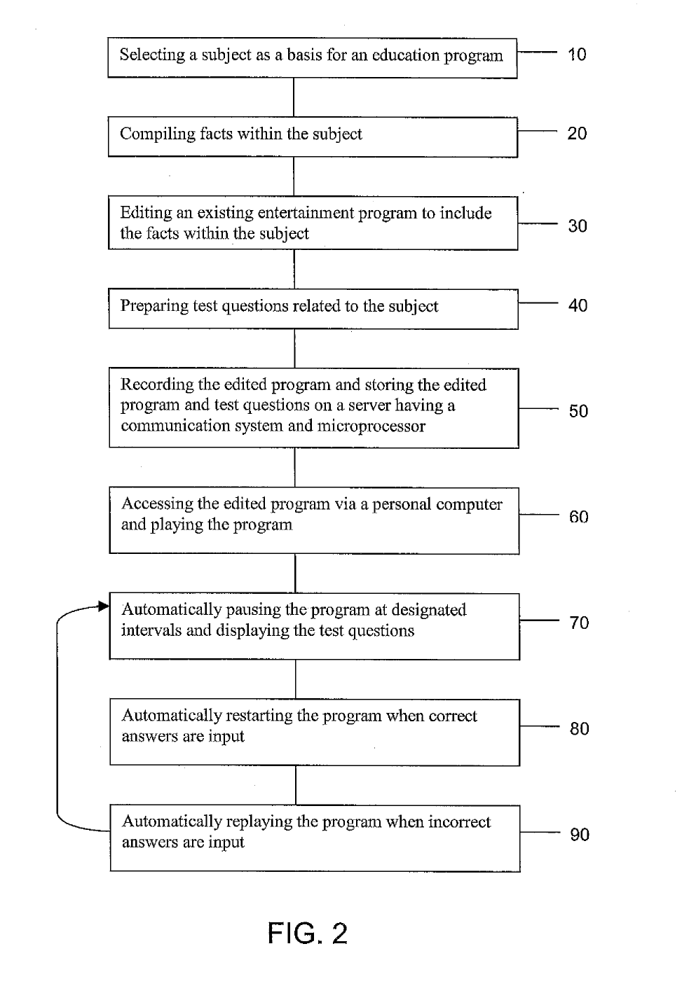

In one embodiment of the invention as shown in FIGS. 1 and 2, a method for providing education has a first step 10 of selecting a subject as the basis of an education program. This could be any subject, such as health care, medicine, law, education, automobile maintenance, dental care, etc. In this embodiment, the subject is infection control by health care providers. In step 20, facts are compiled within the subject for inclusion in the education program. These facts form the basis for teaching the participants in the program and the accompanying tests during the program.

In Step 30, an existing entertainment program is edited to include the facts within the subject. This entertainment program can be a television show, a movie, ballet, opera, play, comedy program or any other type of entertainment program. For example an existing television program that starts nurses and doctors can be edited to include the specific facts compiled in step 20.

In step 40, test questions 3 are prepared based on the facts compiled in step 20.

In step 50, the edited entertainment program 2 is recorded and stored along with the test questions on a server 1 having a communication system 5 for connection to the internet, and a microprocessor 4 for controlling the playback of the entertainment program 2 and the communications with the participant computer 6. The server 1 also has an interface for access by computers of participants. The participants can access the entertainment program using personal computers 6, tablets or smartphones with internet access, in step 60. Once the participant logs into the server 1 having the educational entertainment program 2, the participant registers for the program, pays for the program using credit card information input into the server 1, and can begin to play the program on their personal computer 6.

In step 70, the program is automatically paused at designated intervals to display the test questions 4 to the participant. The participant is given an opportunity to input answers to the test questions into the server 1 via an interface on the participant's computer 6. If the correct answers are input, the program is automatically restarted in step 80 to continue on from the point at which it was paused, until another designated test point is reached. At the new designated test point, additional test questions are displayed for the participant to answer. Each group of test questions is directly related to the facts conveyed in the segment of the program that was displayed immediately previously.

If a question is answered incorrectly, or if the participant does not input the correct answers within a designated amount of time, the program will rewind and begin playing from a designated starting point in step 90, until it reaches the point in the program where the test questions are displayed again. The program continues replaying until all test questions in that group are answered correctly.

When the all test questions have been answered correctly and the program is completed, the participant is eligible for CE credits. These credits can be sent directly to the accrediting agency by the microprocessor 4 and server 1, and a completion certificate 7 can be automatically issued to the participant.

Supplemental materials 9 could be made available during the movie in electronic format, and could contain additional educational materials relevant to the subject being discussed. These materials can be downloaded and read before, during or after the movie.

Accordingly, while only a few embodiments of the present invention has been shown and described, it is obvious that many changes and modifications may be made thereunto without departing from the spirit and scope of the invention.

What is claimed is:

1. A method for providing education comprising the following steps:
selecting a subject as the basis of an education program;
compiling facts within the subject for inclusion in the education program;
editing an entertainment program to include the facts within the subject;
preparing test questions related to the subject;
recording the edited entertainment program and storing the edited entertainment program and test questions on a server having a communication system for connection to the internet and a microprocessor;
accessing the edited entertainment program via a personal computer and playing the program;
automatically pausing the program via the microprocessor at designated intervals and displaying the test questions via the microprocessor;
automatically restarting the program via the microprocessor when correct answers to the test questions are input into the personal computer;
automatically replaying the program via the microprocessor from a designated time in the program when incorrect answers are input into the personal computer.

2. The method according to claim 1, wherein the entertainment program is selected from the group consisting of an opera, a play, a ballet, a musical, a movie and a comedy program.

3. The method according to claim 1, further comprising the steps of creating supplementary materials containing the facts and automatically providing said supplementary materials to the participants in an electronic file during said step of accessing.

4. The method according to claim 1, further comprising setting a price for the program and automatically collecting payment from each participant via the microprocessor.

5. The method according to claim 1, wherein the subject is continuing education in the fields of nursing, medicine, law, or education.

6. The method according to claim 1, further comprising the step of automatically sending a completion certificate to the personal computer at the end of the program.
